(19) United States
(12) Patent Application Publication
(10) Pub. No.: US 2016/0036721 A1
(43) Pub. Date: Feb. 4, 2016

(54) System for Detecting and Managing Application Traffic in Mobile and Fixed Networks

(71) Applicant: BroadView Communications, LLC, Schaumburg, IL (US)

(72) Inventors: William A. Payne, III, Glen Ellyn, IL (US); Irfan Ali, Istanbul (TR); Wesley Stuart Jones, Palatine, IL (US)

(73) Assignee: BROADVIEW COMMUNICATIONS, LLC, Schaumburg, IL (US)

(21) Appl. No.: 14/812,292

(22) Filed: Jul. 29, 2015

Related U.S. Application Data
(60) Provisional application No. 62/032,323, filed on Aug. 1, 2014.

(51) Int. Cl. H04L 12/911; H04L 29/08; H04W 4/24; H04L 12/26

(52) U.S. Cl. CPC H04L 47/783; H04L 43/0888; H04L 67/10; H04W 4/24

(57) ABSTRACT

A system capable of detecting data within user application streams to manage or control the chains. For example, the system can receive bandwidth information from the application, and based on that information, determine a level of network traffic caused by the application. Such bandwidth information can include any one or more of subscription information, information provided by an application running on a user device, information provided by an application function, and a detected application type. Based on the bandwidth information, the system can either determine a service chain route for the stream, or determine how to bill for the traffic caused by the application. For example, such determinations may be conducted dynamically based on previously determined if/then rules established by a user of the system.

### CROSS REFERENCE TO RELATED APPLICATIONS

The present application claims priority to provisional application No. 62/032,323, filed Aug. 1, 2014, the contents of which are incorporated by reference herein in their entirety.

### TECHNICAL FIELD

The present invention relates generally to network engineering. More particularly, the present invention relates to the identification, analyses, and management of application traffic in networks.

### BACKGROUND OF THE INVENTION

So-called Over-the-Top (OTT) applications are prevalent in network communications. These applications deliver audio, video, and other media over, for example, the Internet while bypassing typical distribution channels. For example, Hulu® users can enjoy video content delivered over the Internet, where such content would otherwise be delivered through distribution channels such as a cable or satellite dish carrier. Other examples of commercial OTT applications include Facebook®, Netflix®, iTunes®, Apple Music®, and other Internet videos and music delivery services.

The number and diversity of OTT applications continues to grow as new and more popular and demanding applications and services come into existence, and smartphones become more prevalent. Over time, the network bandwidth needed to support these applications must also grow, therefore increasing the demand for network bandwidth growth in a mobile operator's (MO's) network.

To satisfy this demand, MO's have implemented traffic optimizer service functions within their network. These traffic optimizers include, for example, web traffic caches, video optimizers, and transmission control protocol (TCP) optimizers. In many cases, low order or redundant bits are eliminated from audio and video streams, and general web and data traffic is buffered or cached to help reduce the total application traffic in the network.

The above functions must be utilized for the appropriate set of applications, and applied within a sequence or “service chain” appropriate to that particular application or set of applications. There is a need for efficient management and control of these service chains, including dynamic control of these chains and service function elements capable of handling multiple network conditions.

Prior systems used deep packet inspection (DPI) to identify applications. DPI can be used within the network to analyze and route user streams and identify application types. However, where an OTT application stream is encrypted, it can be difficult to determine certain information from the streams.

### SUMMARY OF THE INVENTION

The present invention broadly comprises a system adapted to detect data within user application streams to manage or control the chains. For example, the system can detect a user application stream or receive information relating to the application, and based on that information, determine a level of network traffic used by the application. Based on the level of traffic, the system can either (1) determine a proper service chain route for the stream; or (2) determine how to bill the application based on the traffic caused by the application.

In an embodiment, the present invention broadly includes a method for controlling a network that includes receiving identifying information of a user device and receiving bandwidth information from the user device. The bandwidth information can include at least one of subscription information of an application running on the user device, a detected application type, information provided by an application function, and information provided by the user device. The method can further analyze the bandwidth information to determine a set of if/then rules, and use the if/then rules to route data traffic within the network.

Another embodiment broadly includes a system having a user device adapted to store an application and a director server adapted to receive identifying information of the user device from the user device, and further adapted to receive bandwidth information from the user device. The bandwidth information can be a subscription information of an application running on the user device, a detected application type, information provided by an application function, and information provided by the user device. The system further includes a producer server adapted to receive and analyze the bandwidth information to determine a set of if/then rules, and to transmit the if/then rules to the director server to allow the director server to route data traffic within the network.

In yet another embodiment, the present invention broadly comprises a computer-readable recording medium having instructions executable by a processor. The computer-readable recording medium can include instructions to receive identifying information of a user device from the user device, and instructions to receive bandwidth information from the user device. The bandwidth information can be a subscription information of an application running on the user device, a detected application type, information provided by an application function, and information provided by the user device. The computer-readable recording medium can further include instructions to analyze the bandwidth information to determine a set of if/then rules, and instructions to use the if/then rules to route data traffic within the network.

### BRIEF DESCRIPTION OF THE DRAWINGS

For the purpose of facilitating an understanding of the subject matter sought to be protected, there are illustrated in the accompanying drawings embodiments thereof, including a preferred embodiment, from an inspection of which, when considered in connection with the following description, the subject matter sought to be protected, its construction and operation, and many of its advantages should be readily understood and appreciated.

FIG. 1 is a schematic block diagram of a mobile wireless network implementing an embodiment of the present invention.

FIG. 2 is a schematic block diagram of a hierarchical subsystem according to an embodiment of the present invention.

FIG. 3 is a schematic block diagram of the director as part of the 3GPP Evolved Packet Core (EPC) according to an embodiment of the present invention.

FIGS. 4a and 4b are collectively a flowchart illustrating a process according to an embodiment of the present invention.

### DETAILED DESCRIPTION OF THE DRAWINGS

While this invention is susceptible of embodiments in many different forms, there is shown in the drawings, and will herein be described in detail, embodiments of the invention, including a preferred embodiment, with the understanding that the present disclosure is to be considered as an exemplification of the principles of the invention and is not intended to limit the broad aspect of the invention to embodiments illustrated. As used herein, the term “present invention” is not intended to limit the scope of the claimed invention and is instead a term used to discuss exemplary embodiments of the invention for explanatory purposes only.

An embodiment of the present invention broadly comprises a network application or service capable of detecting data within user application streams and managing or controlling service chains to efficiently utilize bandwidth in a network. For example, the present invention can include network functionality that detects and manages network application traffic by detecting a user application stream, receives information from the application or an application function, or receives subscription information relating to the application. Once the information is received, the system can detect the level of network traffic used by the application. Based on the level of network traffic, the system can either determine a service chain route for the stream, or determine how to bill for the additional traffic used by the application.

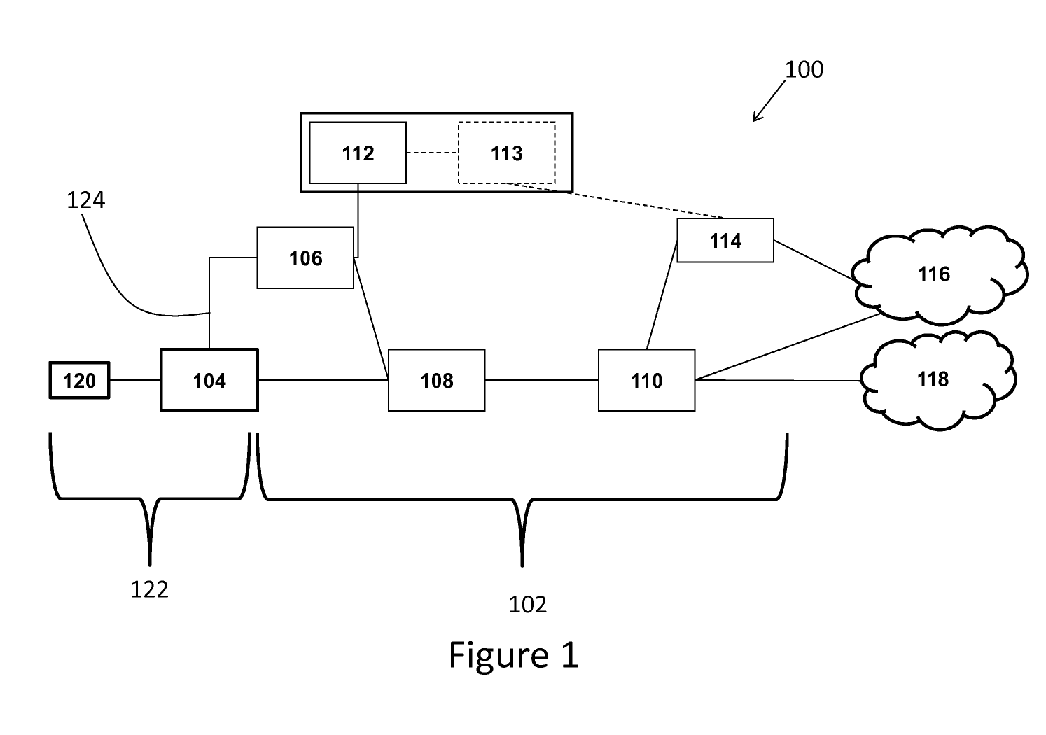

Referring to FIG. 1, in an embodiment of the present invention, the network 100 can include an Evolved Packet Core (EPC) 102 that provides the core routing, switching, control, and service management functions for wireless base stations 104. The network 100 can also include a mobility management entity 106, server gateway 108, packet gateway 110, home subscriber service 112 with subscription profile registry 113, policy and charging rules function 114, and operator services network 116, all operatively coupled together. The Internet 118 can also be coupled to the remainder of the network 100 via the packet gateway 110 and can provide information to the remainder of the network 100 via the gateway. A user device 120, for example, a user's smart phone, can be coupled to the wireless base station 104 within a radio access network 122. The above components can be connected together via communication links 124. Except as specifically described herein, the above features have a meaning as understood in the art.

The EPC 102 can be an Internet packet (IP) based network that provides packet based routing and stream processing for a variety of access networks. The home subscriber service 112 can service subscribers of the network 100 based on subscriber information. For example, the home subscriber service 112 can store names, billing information, and preferences of subscribers of the OTT application. Such information can be stored within the subscription profile registry 113.

The policy and charging rules function 114 can include the predetermined rules for routing streams in real time, or billing users based on the stream information. These rules can be stored within a database, for example.

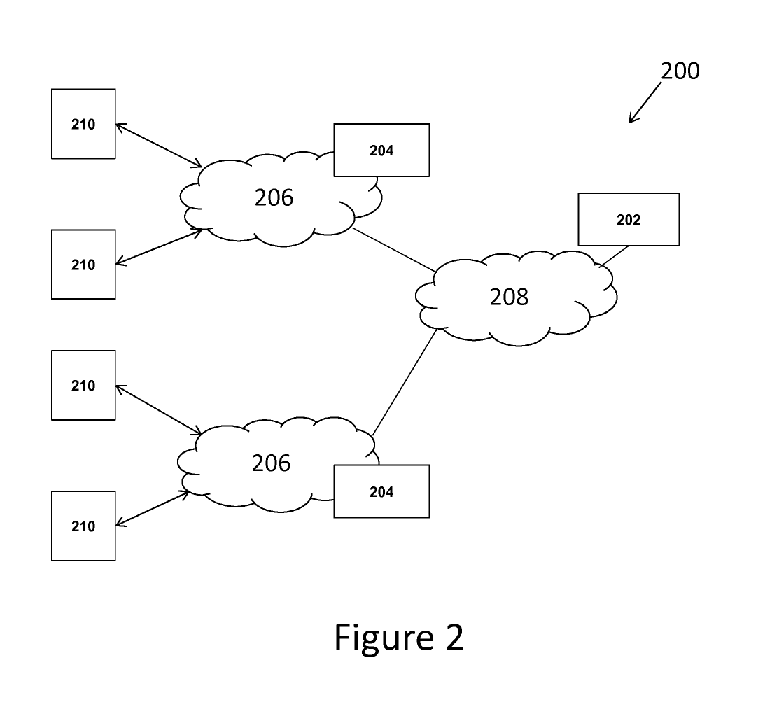

The operator services network 116 includes optimizer services functions to optimize the operation of the network. For example, entities within the operator services network 116 can detect user application streams, analyze network conditions based on the analysis of the user application streams, and instruct the EPC 102 to dynamically route the streams through the optimal service chains based on “if/then” rules predetermined by the user, or the user's subscription data. Alternately, or in addition to the above, the rules may be based on current network traffic conditions determined in real time by the operator services network 116. In an embodiment, the operator services network 116 uses subscriber location information (for example, a GPS coordinate of user device 120) stored within the subscription profile registry 113 or provided to the operator services network 116 in real time to analyze the highest traffic locations in the network 100 (so-called “hot spots”) and to understand the overall traffic conditions in the network 100. Referring also to FIG. 2, in an embodiment, the system 200 includes a producer 202 positioned top most in the network hierarchy, and a director 204 positioned in a mobile network 206 of the user as part of the EPC 102. The director 204 can be operatively coupled to a viewer 210 via the mobile network 206, and the producer 202 can be operatively coupled to the director 204 through the operator network 208. For example, the producer 202 can be positioned in a Network Operations Center (NOC) where overall network traffic is analyzed and managed. Typically, a single producer 202 can exist for multiple directors 204, and a single director 204 for multiple viewers 210, although the present invention is not so limited.

The producer 202 can have several functions. For example, the producer 202 can include a graphic user interface (GUI) so that an operator of the system 200 can implement the rules input by an operator of the system 200. These rules can then be used to route network traffic via the directors 204, and can be, for example, if/then rules. The producer 202 can also compile code that, when executed, analyzes the network information provided by the directors 204, and subsequently, provide the directors 204 with conditional decisions required for the proper selection of service functions and service function chains. Director 204 software updates can also be stored at the producer 202, and updated at the director 204, as needed. Similarly, the viewer 210 can request and receive downloads from the producer 202, for example, applications that can be run on the user device 120 or updates to the viewer 210 application. Such downloads can be transmitted from the producer 202 to a subset of viewers 210, for example, to account for parental controls, or can be automatically or manually requested by the viewer 210.

The director 204 routes network traffic according to the rules provided to the director 204 by the producer 202. In general, the director 204 can more highly regulate those services that place a heavier burden on network traffic (“bad actors”), while allowing more free reign for the services that place a lesser burden on network traffic (“good actors”). For example, the director 204 may allocate less bandwidth for a bad actor service, or charge the bad actor more, compared to a good actor, to utilize the network architecture.

In an embodiment, the viewer 210 can be located with the end user of the system 200. For example, the viewer 210 can be a mobile application stored and executed by a smartphone. In some embodiments, the viewer 210 is managed by one director 204 within a local EPC 102, and also managed by the overall producer 202 of the system 200, although the present invention is not so limited. The director 204 can manage the viewer 210 by implementing the rules established by the producer 202, and by collecting data from the viewer 210 and distributing it to the producer 202 so that the operator may input rules for the system 200.

The producer 202 can receive and analyze data from the overall system 200, while the director 204 can receive and analyze data from the mobile network 206. Also, the viewer 210 can receive and analyze data relating to the individual user's activities on the network 206. For example, the user device 120 can receive, store, and transmit to either the producer 202, director 204, or any other entity, information relating to the activities of the user.

The various rules implemented by the producer 202 can be used to optimize or otherwise control network bandwidth usage. For example, the operator can create if/then rules at the producer 202 to establish priority for certain applications that use the network, or conversely de-prioritize certain applications. In some embodiments, higher priority applications will not incur as much processing by network optimizers, and will therefore be allocated more bandwidth by the rules. Conversely, in an embodiment, lower priority applications will incur a larger degree of processing in the system 200, thus having their network bandwidth usage reduced. In some embodiments, lower priority applications can be charged an additional amount for the bandwidth they use, compared to the higher priority applications. For example, the producer 202 can implement rules that charge fees to those applications that use a greater amount of network resources and bandwidth, which can compromise the performance of other applications utilizing the system 200.

As discussed above, the producer 202 operates at the highest level of the system 200 hierarchy. However, if the producer 202 somehow becomes nonoperational, the director(s) 204 can continue to perform their respective functions based on the current configuration of the directors 204. Of course, the directors 206 would not be able to obtain updates from a nonoperational producer 202, but can once the producer 202 becomes operational once again. Similarly, the viewer 210 will not go out of operation simply because the producer 202 or director 204 is nonoperational. Rather, the viewer 210 can continue with its current settings and transmit data to the director 204 once the director 204 and/or producer 202 become operational again. In some embodiments, faults in the director 204 are presented to the producer 202, which can then take corrective action. Similarly, faults in the viewer 210 are presented to the director 204, which can take corrective action with or without assistance from the producer 202.

In some embodiments, the producer 202 can include a graphic user interface (GUI) to allow operators of the system 200 to implement if/then rules and other operational parameters via the directors 204 to, for example, route applications through a set of service functions or chains in a particular network. The interface can also allow the operator to view the utilization of resources on the system 200, application popularity, and network bandwidth usage within the system. This information can then be used by the operator to create if/then rules for network routing or additional billing. In some embodiments, the interface allows the operator to view the different viewers 210 and directors 204 on the system 200 through deep packet inspection techniques utilized by the directors 204 in each of the mobile networks 206.

As discussed above, the producer 202 can receive data from the viewers 210 via the directors 204. However, the producer 202 can also collect and compile data from other sources. For example, the producer 202 can request or receive information from third party and operator-owned databases or other network elements that collect and provide additional data that can be utilized to create rules for network traffic management. In some embodiments, such data can include viewer 210 usage patterns based on location or other user behavior, or user subscription information (e.g., names, addresses, or billing information of the users). Any information that is relevant to the usage of bandwidth on the system 200 network can be stored by the viewer 210 and transmitted to the director 204 and/or the producer 202.

In some embodiments, the producer 202 and director 204 can be separate servers having a non-transitory computer-readable recording medium that stores instructions executable by a processor. In other embodiments, the producer 202 and director 204 can be part of the same server. The producer 202 and director 204 can also be executed remotely as a cloud based software, for example, a service (SaaS) type of arrangement. The non-transitory computer-readable recording medium can be any non-transitory medium capable of storing digital data, such as a hard drive, DVD, CD, flash drive, volatile or non-volatile memory, RAM, or any other type of data storage. As used throughout this application, the term “non-transitory computer-readable recording medium” excludes only signals and carrier waves, per se, and is not meant to exclude other types of memory that may be considered “transitory” such as RAM or other forms of volatile memory.

In an embodiment, the viewer 210 can be a software application stored on the user device 120. The viewer 210 can store and transmit information relating to bit rate and network resources consumed per application on the user device 210. In an embodiment, this information is transmitted to the director 204 associated with the viewer 210 in the system 200 so the director can transmit the information to the producer 202, where appropriate rules are created that the director 204 can carry out. The viewer 210 can also assist subscribers by providing information relating to the geographic area in which the viewer 210 is used, the community of users interacting with the viewer 210, the community of applications interacting with the viewer 210, and other user- or application-based information. This information can help subscribers identify optimum conditions in which their application can be run within the system 200 and determine the appropriate level of priority for the viewer 210. The information can further assist the subscribers by providing the amount of bandwidth consumed by a user device 120 using the viewer 210.

The viewer 210 can be stored within the user device 120 in any manner. For example, the viewer 210 can be permanently installed by the operator of the system 200, the user who owns the user device 120, or based on permission-based parameters (e.g., a password) if parental controls are implemented.

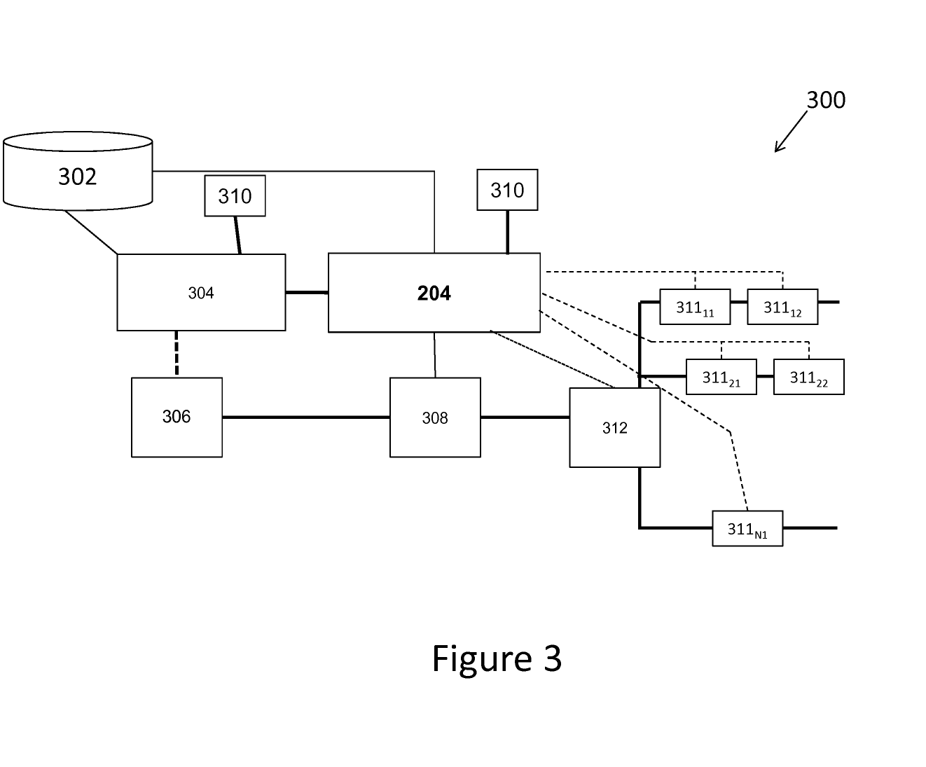

Referring to FIG. 3, a typical 3GPP Evolved Packet Core network can include a Home Subscriber Server (HSS) 302 as the master database of all subscribers in the operator's network. The HSS 302 can store the subscription-related information to support other network entities handling calls and sessions. The EPC 300 can also include a Policy and Charging Rules Function (PCRF) 304 that acts as a policy decision point for policy and charging control of service data flows and applications. The PCRF 304 can include a Subscription Profile Registry (SPR) logical entity that stores all subscriber and subscription related information needed for subscription-based policies and charging control by the PCRF 304. The EPC 300 can also include a Policy and Charging Enforcement Function (PCEF) 306 that acts as a policy enforcement point for policy and charging control of IP bearer resources. Further included is a Traffic Detection Function (TDF) 308 that acts as a functional entity to perform application detection through the use of Deep Packet Inspection (DPI) techniques or other detection techniques. Application

Functions (AF) 310 can also be operatively coupled to the director 204 and PCRF 304, and can transmit information relating to the user device 120 or viewer 210. Service functions 311ₓₓ can be operatively coupled to the remainder of the EPC 300 by a router 312. Although shown as separate entities in FIG. 3, the director 204 and PCRF 304 can be combined together as one entity.

The SPR 302 can allow the transfer of subscription information (for example, an indication that the subscriber is a gold, silver, or bronze member with associated bandwidth priorities) from the SPR 302 to the director 204. The interface between the SPR 302 and the director 204 can be a subset of the standard Sp interface specified in 3GPP TS 23.203.

The interface between the director 204 and the TDF 308 can be the Sd interface, as specified in 3GPP TS 23.203 and other relevant 3GPP specifications. This interface is used by the director 204 to control which applications should be detected by the TDF 308. The TDF 308 also informs the director 204 about a detected application and the corresponding IP flows for the application.

The interface between the director 204 and AF 310 can be the Rx interface, as specified in 3GPP TS 23.203 and other relevant 3GPP specifications. Although FIG. 3 shows only one AF 310 interacting with the director 204, the present invention is not so limited, and any number of AFs 310 may interface with the director 204. The Rx interface can be used by the AF 310 to inform the director 204 about IP flows of a user device 120 application and the type of traffic (e.g. audio, video, chat) relating to the application. This information, among others, allows the director 204 to determine the service functions to apply to a particular flow.

The interface between the director 204 and the PCRF 304 can be the Da interface as specified in 3GPP TS 23.203 and other relevant 3GPP specifications. This interface can be used by the PCRF 304 to inform the director 204 about the IP address corresponding to each user of the system 200. In some embodiments, the IP address can be used to determine a user's identify.

The interface between the director 204 and the router 312 can be the Db interface, as specified in 3GPP TS 23.203 and other relevant 3GPP specifications. The router 312 can be used by the director 204 to route IP traffic of different applications through different traffic chains. The 3GPP Command Line Interface (Dx) can also be used between the director 204 and the router 312, or any other interface that allows separate control of the forwarding operation of the router 312. In some embodiments, the router 312 is an open flow switch or a third party switch or router.

The interface between the director 204 and the service functions 311ₓₓ can be the Dc interface (for example, OpenStack), as specified in 3GPP TS 23.203 and other relevant 3GPP specifications. This interface can be used by the Director to control the application functions of the system 200, for example, add more memory or processing power to the service functions 311_{NN} as load on the service functions 311ₓₓ increases.

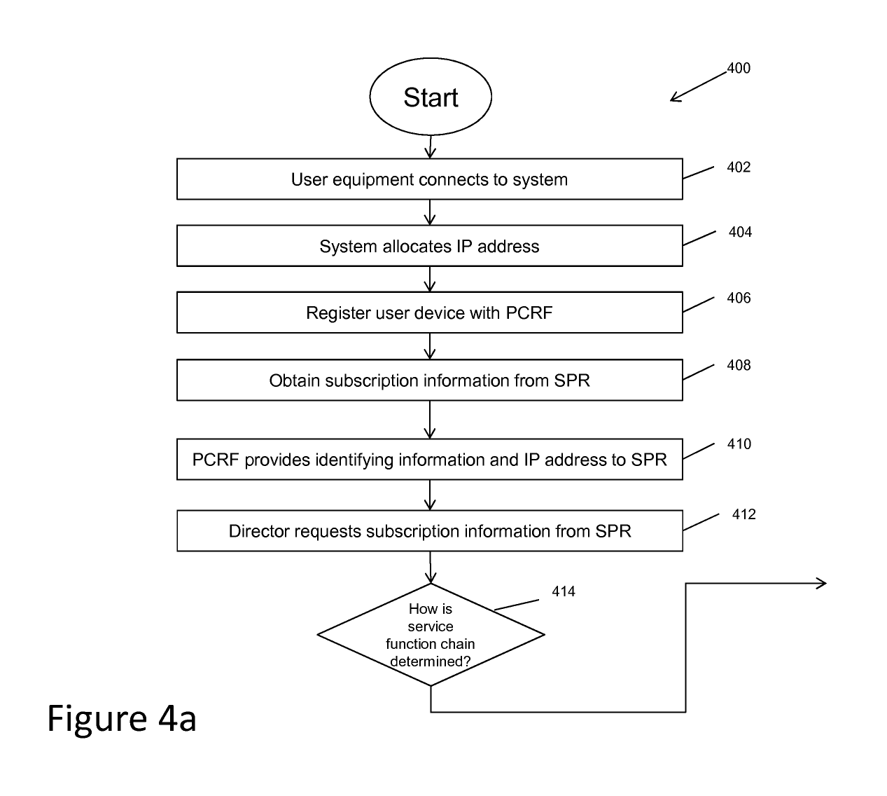

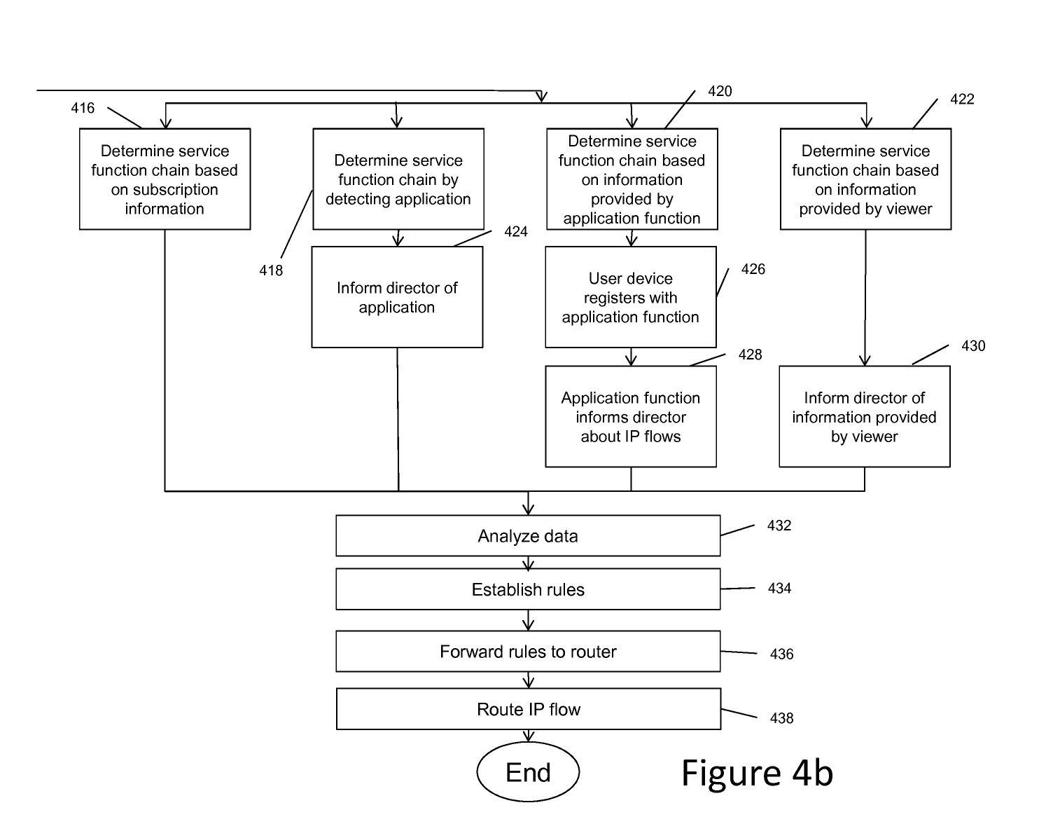

Referring to FIG. 4, an embodiment of the present invention broadly includes a method that begins with the user device 120 connecting to the system 200 in step 402. At this time, the identity of the user device 120 is provided to the system through International Mobile Subscriber Identity (IMSI) or Mobile Subscriber Integrated Services Digital Network-Number (MSISDN) means, for example. The system 200 can then allocate an IP address or other such identifying information for the user device 120 while also signaling back the address to the user device 120 in step 404.

The method 400 continues to step 406 where the user device 120 registers itself with the PCRF 304. For example, the user device 120 can provide its identity along with the assigned IP address of the user device 120 to the PCRF 304. The PCRF 304 can then obtain the subscription information of the user device 120 from the SPR 302 in step 408. For example, the PCRF 304 can provide identifying information of the user device 120 to the SPR 302, and based on the identifying information, the SPR 302 can provide the subscription information of the user device 120 to the PCRF 304.

The PCRF 304 can then provide both the user identifying information and the IP address of the user device 120 to the director 204 in step 410. The director 204 can then request subscription information from the SPR 302 in step 412 by providing the user identifying information to the SPR 302. Steps 410 and 412 can optionally be omitted when the director 204 and PCRF 304 are a combined entity.

In step 414, it is determined how the service function chain is selected. For example, the determination of the service function chain can be based on subscription information only (as in step 416), based on detecting the application via, e.g., deep packet inspection (as in step 418), based on information provided by the application function (as in step 420), or based on information provided by the viewer (as in step 422). Any one or more of these types of information can be used to determine how the function chain is selected, and this information can collectively be referred to as “bandwidth information.”

If the result of step 414 is step 416, the director 204 determines the service function chain based on user device's subscription information and directs all the user device's traffic to a particular service chain in step 416.

If the result is step 418, the director 204 requests the TDF 308 to detect specific applications for the user device 120 by providing application detection and control rules to the TDF 308 in step 418. For example, the TDF 308 can implement application detection and control rules as captured in 3GPP Specifications, for example, TS 23.203, or the TDF 308 can be preconfigured with static application detection and control rules to detect different applications of the user device 120, in which case step 418 can be omitted. The TDF 308 can then inform the director 204 of the detected application and the IP flows associated with the application in step 424.

If the result is step 420, the user device 120 registers with an application function in step 426. When the user device 120 starts using the application, the application function informs the director 204 about the details of the IP flows that belong to the particular application and details of the application in step 428.

If the result is step 422, the user device 120 informs the director 204 about the details of the IP flows that belong to the particular application and details of the application itself in step 430. This is similar to step 420, except in step 422, the viewer 210 performs the “reporting” function rather than an application function 310.

Following any one or more of steps 416-430, the director 204 then analyzes the data in step 432. This determination may be made based on any factor contributed by any one or more of the subscription information (step 416), the detection of the application (steps 418 and 424), or the determination of the service chain function based on information provided by an application function (step 420) or the viewer (step 422). For example, the director 204 can forward this data to the producer 202 for display on the GUI of the producer 202.

The operator of the system 200 can then analyze the data and create a set of rules, for example, if/then rules, to be carried out on the applications, in step 434. Alternately, the director 204 or producer 202 can quantify the data based on the historical effect the data has on network traffic. For example, the type of application may be a large contributing factor to overall network traffic, and thus the system 200 can account for this increased traffic when determining if/then rules. Still alternately, the system 200 can analyze the data and determine the appropriate rules automatically based on a predetermined algorithm establishing an optimum IP flow based on the analyzed data. Any other method of analyzing the bandwidth information to determine if/then rules can be implemented without departing from the spirit and scope of the present invention.

Once the IP flow rules are determined, the method 400 proceeds to step 436, where the rules are forwarded to the router 312. The router 312 then routes the IP flow in step 438 according to the rules, and the process 400 ends.

In an embodiment, the director 204 may encapsulate the IP packets in another IP packet, also known as “tunneling,” which has the destination address of a first service function. In the encapsulation, the director 204 also provides metadata to enable the service function to further forward the IP packet to the next service function in the chain. In an embodiment, the viewer 210 can assist users in meeting other users. For example, the viewer 210 can connect users to other users on social media platforms to develop broader views on topics relating to products, entertainment, services, traffic, incidences, and politics, for example.

Several elements of the present invention are discussed above with single or plural terms. However, each element discussed above can be singular or plural in number, and the examples above are merely exemplary.

Several processes discussed above are described in chronological order. However, any order of the disclosed and claimed processes can be implemented without departing from the spirit and scope of the present invention. Further, any step of the disclosed methods can be omitted.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A method for controlling utilization of a network for an application on a user device, comprising:
receiving identifying information from the user device;
receiving bandwidth information from the user device, the bandwidth information being at least one of subscription information of a user of the user device, a detected type of the application, information provided by a function of the application, and information provided by the user device;
analyzing the bandwidth information to determine a set of if/then rules; and
using the if/then rules to route data traffic for the application on the network.

2. The method of claim 1, wherein the if/then rules include allocating an amount of bandwidth to the application.

3. The method of claim 1, wherein the if/then rules include charging the user based on the bandwidth information.

4. The method of claim 1, wherein when the bandwidth information includes a detected type of the application, detecting the application type with deep packet inspection techniques.

5. The method of claim 1, wherein when the bandwidth information includes information provided by a function of the application, registering the user device with the function.

6. The method of claim 1, wherein the step of receiving identifying information from the user device includes:
receiving an indication that the user device is connected to the network;
allocating an address to the user device; and
registering the user device.

7. The method of claim 1, wherein the subscription information includes information relating to a permissible bandwidth usage for the application based on an application subscription.

8. The method of claim 1, wherein the step of analyzing the bandwidth information includes providing an interface for displaying the bandwidth information and receiving the if/then rules from an operator of the network.

9. A system for controlling utilization of a network for an application on a user device, comprising:
a director server adapted to receive identifying information and bandwidth information from the user device, the bandwidth information being at least one of subscription information of the application, a detected type of the application, information provided by a function of the application, and information provided by the user device; and
a producer server adapted to receive and analyze the bandwidth information to determine a set of if/then rules, and to transmit the if/then rules to the director server to allow the director server to route data traffic for the application on the network.

10. The system of claim 9, wherein the if/then rules include allocating an amount of bandwidth to the application.

11. The system of claim 9, wherein the if/then rules include charging a user of the user device based on the bandwidth information.

12. The system of claim 9, wherein when the bandwidth information includes a detected application type, the director is further adapted to determine the application type with deep packet inspection techniques.

13. The system of claim 9, wherein the director is further adapted to:
receive an indication that the user device has been connected to the network;
allocate an address to the user device; and
register the user device.

14. A computer-readable recording medium having instructions executable by a processor, comprising:
instructions to receive identifying information from the user device;
instructions to receive bandwidth information from the user device, the bandwidth information being at least one of subscription information of an application running on the user device, a detected application type, information provided by an application function, and information provided by the user device;
instructions to analyze the bandwidth information to determine a set of if/then rules; and
instructions to use the if/then rules to route data traffic within the network.

15. The computer-readable recording medium of claim 14, wherein the if/then rules include allocating bandwidth to the application.

16. The computer-readable recording medium of claim 14, wherein the if/then rules include charging the application based on the bandwidth information.

17. The computer-readable recording medium of claim 14, wherein when the bandwidth information includes a detected application type, further comprising instructions to detect the application type with deep packet inspection techniques.

18. The computer-readable recording medium of claim 14, wherein when the bandwidth information includes information provided by an application function, further comprising instructions to register the user device with the application function.

19. The computer-readable recording medium of claim 14, wherein the instructions to receive identifying information of a user device from the user device include:
instructions to receive an indication that the user device has been connected to the network;
instructions to allocate an address to the user device; and
instructions to register the user device.

20. The computer-readable recording medium of claim 14, wherein the subscription information includes information relating to a permissible bandwidth usage of the application based on an application subscription.
